(19) United States
(12) Patent Application Publication
(10) Pub. No.: US 2006/0267345 A1
(43) Pub. Date: Nov. 30, 2006

(54) Engine starter for remote-control toy car

(76) Inventor: Ke-Way Lu, Taipei City (TW)

Correspondence Address: Richard P. Berg;Ladas & Parry, Suite #2100, 5670 Wilshire Boulevard, Los Angeles, CA, 90036-5679, US

(21) Appl. No.: 11/136,855

(22) Filed: May 24, 2005

(51) Int. Cl. F02N 11/00; H02P 9/04

(52) U.S. Cl. 290/38 R

(57) ABSTRACT

An engine starter for remote-control toy car is disclosed to include a switch cover for protecting the power switch thereof to prevent triggering of the power switch accidentally, a power input/output connector for receiving external power supply and transmitting received external power supply to the battery thereof or for transmitting battery power supply from the battery to an external electric apparatus, a power socket for power output from the battery to the igniter of the engine of the remote-control toy car, an overload protector for breaking the circuit between the motor of the engine of the remote-control toy car and the battery upon an overload, and a connector switch for controlling electric connection between the battery and the motor of the engine starter.

### BACKGROUND OF THE INVENTION

1. Field of the Invention

The present invention relates an engine starter and more particularly, to an engine starter for remote-control toy car.

2. Description of the Related Art

The engines used in regular engine-operated remote-control toy cars are developed through several generation improvements. The engine for remote-control toy car of the first generation is to be started with a drag rope. An engine of this design has numerous drawbacks. One drawback of this design of engine is its complicated structure. Another drawback of this design of engine is that the rope tends to break during operation. Still another drawback of this design of engine is that the one-way bearing wears quickly with use.

In order to eliminate the aforesaid drawbacks, an engine of second generation was developed. This design is based on the engine design of the aforesaid first generation, having a starter barrel coupled to the one-way bearing for rotating the output shaft of the engine with a drag rope or an electric engine starter as desired. This second generation engine design has the same drawbacks of the aforesaid first generation engine design. Further, an electric engine starter for starting this second generation engine design is quite heavy.

A third generation engine design uses an electric engine starter to start the engine and eliminates the use of a drag rope. According to this third generation engine design an one-way bearing, a partition board and a driven gear are mounted in proper order on a center rod, which extends out of the cylinder block of the engine. The driven gear is meshed with a drive gear at a side cover that is covered on the cylinder block of the engine. The drive gear is affixed to a starter barrel, which is rotatably mounted in a through hole of the side cover and has two longitudinal crevices. An electric engine starter is used and coupled to the longitudinal crevices of the starter barrel, and controlled to rotate the center rod and to further start the engine.

A conventional electric engine starter is known comprising a platform carrying a motor, a battery, a power switch, and a transmission gear set. When switched on the power switch, the motor is started to turn the transmission gear set, thereby causing the transmission gear set to drive a starter shaft to start the engine of the remote-control toy car. Further, when driving the starter shaft to start the engine, an igniter must be turned on to drive the ignition plug of the engine to produce sparks for burning fuel mixture.

Further, if the battery power of a conventional electric engine starter is used up, the battery of the electric engine starter must be replaced. Further, the battery of a conventional electric engine starter is not connectable to an external electric apparatus to provide the external electric apparatus with the necessary working voltage. Further, if the engine fails or sticks, the motor of the electric engine starter may be burned out when starting the engine. Further, because the power switch of a conventional electric engine starter is exposed to the outside, the user may trigger the power switch accidentally. Further, because the connector switch that connects the battery to the motor electrically is disposed outside the casing of the electric engine starter, the electric wires of the connector switch may hinder the operation of the user.

### SUMMARY OF THE INVENTION

The present invention has been accomplished under the circumstances in view. According to one aspect of the present invention, the engine starter comprises a motor, a battery, a power switch for controlling supply of battery power from the battery to the motor, a transmission gear set coupled to the motor and rotatably by the motor, the transmission gear set comprising an output shaft, and a starter shaft connected to the output shaft of the transmission gear set and rotatable by the transmission gear set for starting the engine of a remote-control toy car, wherein the engine starter further comprises a switch cover pivoted thereto and turnable between a first position wherein the switch cover covers the power switch and a second position where the switch cover is opened from the power switch. According to another aspect of the present invention, the engine starter further comprises a connector switch adapted to control electric connection between the battery and the motor. According to still another aspect of the present invention, the engine starter further comprises a power input/output connector provided at a rear side thereof and electrically connected to the connector switch for receiving external power supply and transmitting received external power supply to the battery, and for transmitting battery power supply from the battery to an external electric apparatus. According to still another aspect of the present invention, the engine starter further comprises a power socket provided at a front side thereof and electrically connected to the battery for power output from the battery to an igniter connected thereto. According to still another aspect of the present invention, the engine starter further comprises an overload protector electrically connected to the battery and the motor and adapted to break the circuit between the battery and the motor upon an overload. According to still another aspect of the present invention, the transmission gear set comprises a pinion fixedly mounted on an output shaft of the motor, a first idling gear meshed with the pinion, a second idling gear meshed with the first idling gear, a driven gear meshed with the second idling gear, and an output shaft fixedly axially connected to the driven gear for receiving and rotating a starter shaft.

### BRIEF DESCRIPTION OF THE DRAWINGS

FIG. 1 is a sectional plain view of an engine starter according to the present invention.

FIG. 2 is a schematic drawing of a part of the present invention, showing the switch cover moved between the close position and the open position.

FIG. 3 is a schematic drawing of the present invention showing the use of the engine starter with an igniter.

FIG. 4 is a schematic drawing of the present invention showing the use of the input/output connector with an external power connector.

FIG. 5 is an elevational view of a conventional eccentric crank type engine for remote-control toy car.

FIG. 6 is an elevational view of a conventional direct acting engine for remote-control toy car.

### DETAILED DESCRIPTION OF THE INVENTION

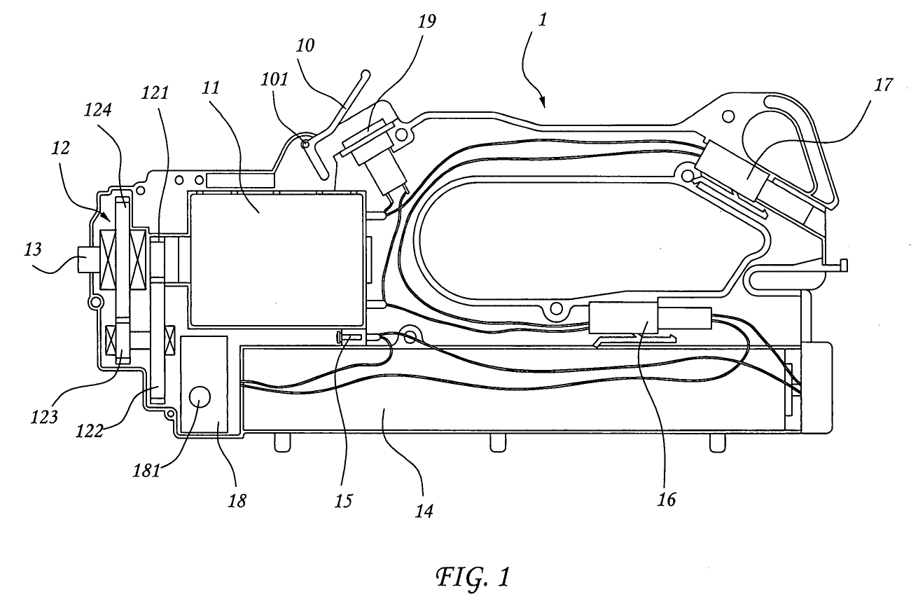

Referring to FIG. 1, an engine starter 1 in accordance with the present invention is shown comprising a motor 11, a battery 14, a transmission gear set 12, a power switch 19, a connector switch 16, an input/output connector 17, a power output socket 15, and an overload protector 18.

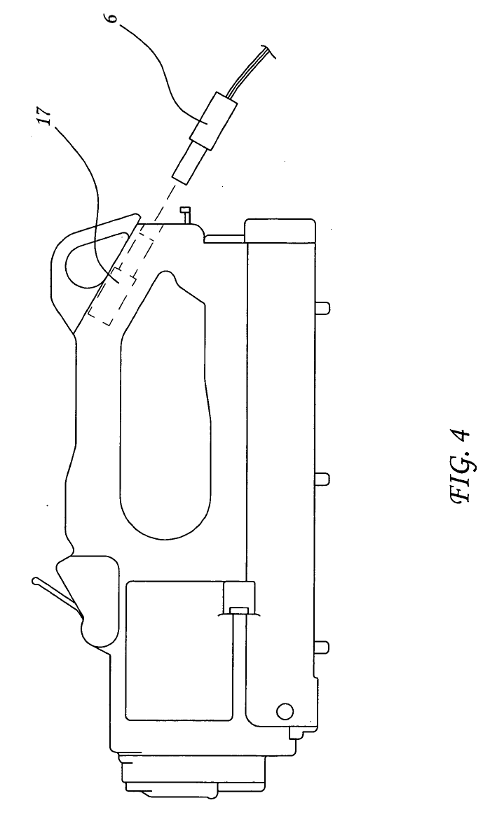

The connector switch 16 is provided with electric wires and worked as electric connection means between the battery 14 and the motor 11. The input/output connector 17 is provided at the rear side of the engine starter 1 and electrically connected to the connector switch 16 for receiving an external power connector 6 (see FIG. 4) to transmit external power supply to the battery 14, or for transmitting battery power supply from the battery 14 to an external electric apparatus.

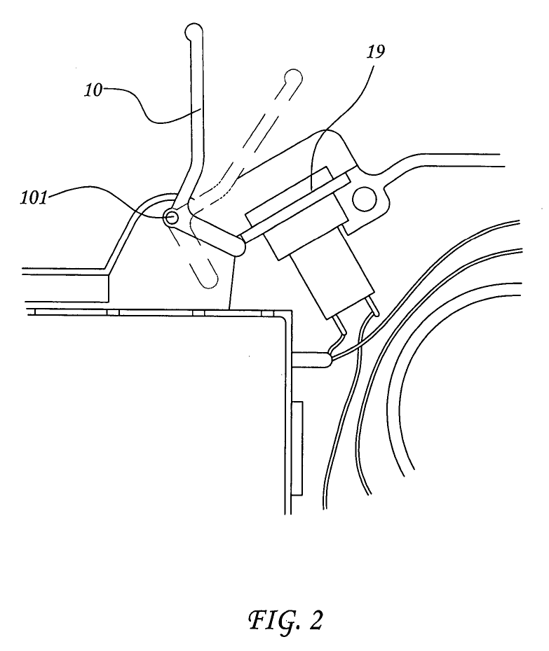

Further, a switch cover 10 is pivotally connected to the engine starter 1 by a pivot 101 and covered over the power switch 19 to prevent triggering of the power switch 19 accidentally. When opening the switch cover 10 (see FIG. 2), the user's hand is accessible to the power switch 19.

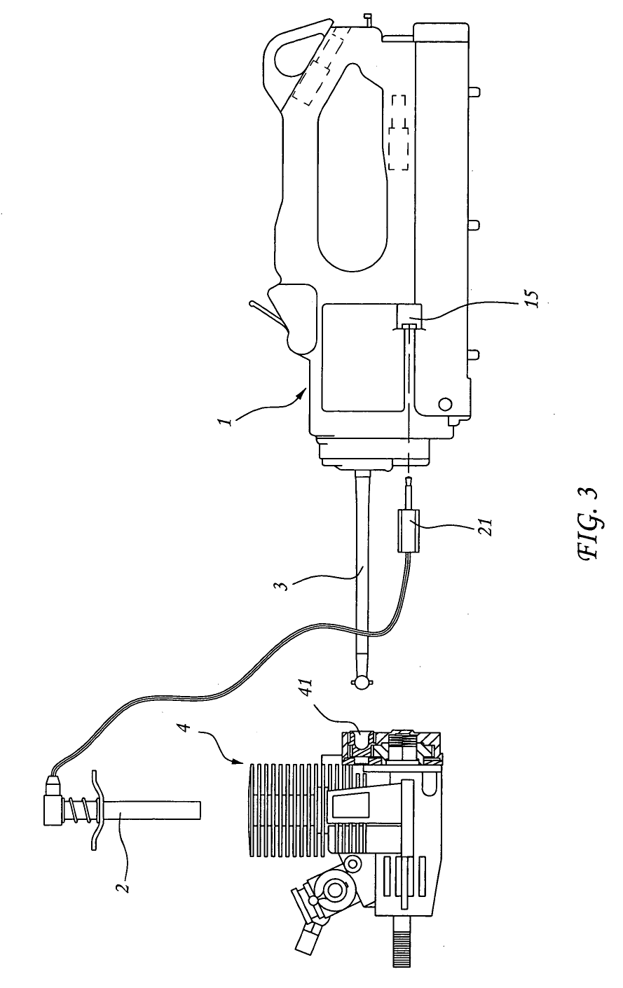

The power output socket 15 is provided at the front side of the engine starter 1 for receiving the power input plug 21 of an igniter 2, which is connectable to the engine 4 of the remote-control toy car (not shown) to transmit power supply from the battery 14 to the ignition plug (not shown) of the engine 4, so that the ignition plug can produce sparks to burn fuel mixture after connection of the starter shaft, referenced by 3, of the engine starter 1 into the coupling hole 41 of the engine 4 to start the engine 4 (see FIG. 3).

If the engine fails or sticks, the engine starter may be burned down. Therefore, an overload protection is needed. The invention uses the overload protector 18 to break the circuit upon an overload. According to the present preferred embodiment, the overload protector 18 is an overload circuit breaker, having a reset switch 181 to reset power supply.

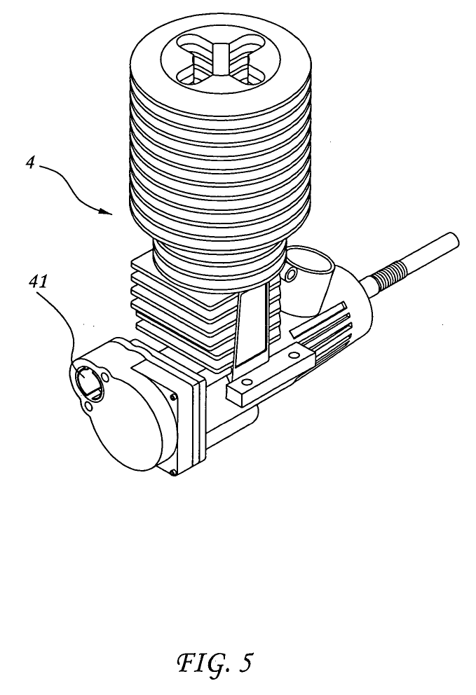

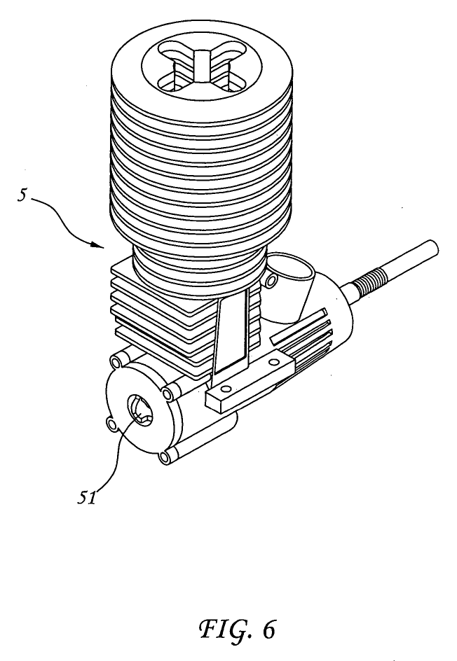

The transmission gear set 12 comprises a pinion 121 fixedly mounted on the output shaft of the motor 11, a first idling gear 122 meshed with the pinion 121, a second idling gear 123 meshed with the first idling gear 122, a driven gear 124 meshed with the second idling gear 123, and an output shaft 13 fixedly axially connected to the driven gear 124. The aforesaid starter shaft 3 is coupled to the output shaft 13 for connection to the coupling hole 41 of the eccentric crank type engine 4 shown in FIG. 5 or the coupling hole 51 of the direct acting engine 5 shown in FIG. 6) to start the engine.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An engine starter comprising:
a motor;
a battery;
a power switch for controlling supply of battery power from said battery to said motor;
a transmission gear set coupled to said motor and rotatably by said motor, said transmission gear set comprising an output shaft; and
a starter shaft connected to the output shaft of said transmission gear set and rotatable by said transmission gear set for starting the engine of a remote-control toy car;
wherein the engine starter further comprises a switch cover pivoted thereto and turnable between a first position wherein said switch cover covers said power switch and a second position where said switch cover is opened from said power switch.

2. The engine starter as claimed in claim 1, further comprising a connector switch adapted to control electric connection between said battery and said motor.

3. The engine starter as claimed in claim 2, further comprising a power input/output connector provided at a rear side thereof and electrically connected to said connector switch for receiving external power supply and transmitting received external power supply to said battery, and for transmitting battery power supply from said battery to an external electric apparatus.

4. The engine starter as claimed in claim 1, further comprising a power socket provided at a front side thereof and electrically connected to said battery for power output from said battery to an igniter connected thereto.

5. The engine starter as claimed in claim 1, further comprising an overload protector electrically connected to said battery and said motor and adapted to break the circuit between said battery and said motor upon an overload.

6. The engine starter as claimed in claim 1, wherein said transmission gear set comprises a pinion fixedly mounted on an output shaft of said motor, a first idling gear meshed with said pinion, a second idling gear meshed with said first idling gear, a driven gear meshed with said second idling gear, and an output shaft fixedly axially connected to said driven gear for receiving and rotating a starter shaft.
